(19) United States
(12) Patent Application Publication
(10) Pub. No.: US 2004/0226135 A1
(43) Pub. Date: Nov. 18, 2004

(54) Shock-absorbing caster dock

(76) Inventor: King-Sheng Wang, Taichung Hsien (TW)

Correspondence Address: BIRCH STEWART KOLASCH & BIRCH, PO BOX 747, FALLS CHURCH, VA, 22040-0747, US

(21) Appl. No.: 10/437,253

(22) Filed: May 14, 2003

(51) Int. Cl. B60B 33/00

(52) U.S. Cl. 16/44

(57) ABSTRACT

A shock-absorbing caster dock includes a dock shell and a caster assembly. The dock shell is fastened to the bottom of a luggage for holding the caster assembly. The caster assembly includes a wheel, two side levers located on two sides of the wheel, a shaft running through the upper portion of the two side levers to pivotally engage with a side wall, and an elastic element coupling on the shaft. The elastic element has a middle portion bucking the side wall and two ends latching and pressing the side levers to provide elasticity for the side wall to withstand the gravity force of the luggage and absorb vibrations.

### FIELD OF THE INVENTION

The present invention relates to a caster dock located on the bottom of a luggage and particularly to a caster dock for absorbing vibration during the luggage is being towed.

### BACKGROUND OF THE INVENTION

Conventional luggage, aside from holding clothes, laundries, cosmetics and personal belongings, also may be used to hold notebook computers to alleviate user's burden of carrying the computer. The notebook computer is fragile and sensitive to shock and vibration. When the luggage is towed on the ground, the bumps on the ground are prone to generate vibrations which shake the computer circuit board and might cause short circuit and result in damaging the computer circuit board. It could cause a great loss to users.

### SUMMARY OF THE INVENTION

The invention aims at providing a shock-absorbing caster dock that has a dock shell and a caster assembly. The dock shell is fastened to the bottom of a luggage for holding the caster assembly. The caster assembly includes a wheel and two side levers to pivotally engage with the wheel on two sides. The side levers are pivotally coupled with a side wall through a shaft on an upper side thereof. The shaft is coupled with an elastic element. The elastic element has a middle portion bucking the side wall and two sides pressing the side levers. Thus when the luggage is towed, vibration and shock may be absorbed to prevent the important articles held in the luggage from being shaken and damaged.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a preferred embodiment of the invention.

FIG. 2 is a perspective view of a preferred embodiment of the invention.

FIG. 3A is an illustrative side view of a preferred embodiment of the invention in use (with the luggage in a upright condition).

FIG. 3B is a detailed sectional view of the invention according to FIG. 3A.

FIG. 4A is an illustrative side view of a preferred embodiment of the invention in use (with the luggage in a towing condition).

FIG. 4B is a detailed sectional view of the invention according to FIG. 4A.

FIG. 5 is a perspective view of a second embodiment of the invention.

### DETAILED DESCRIPTION OF THE PREFERRED EMBODIMENTS

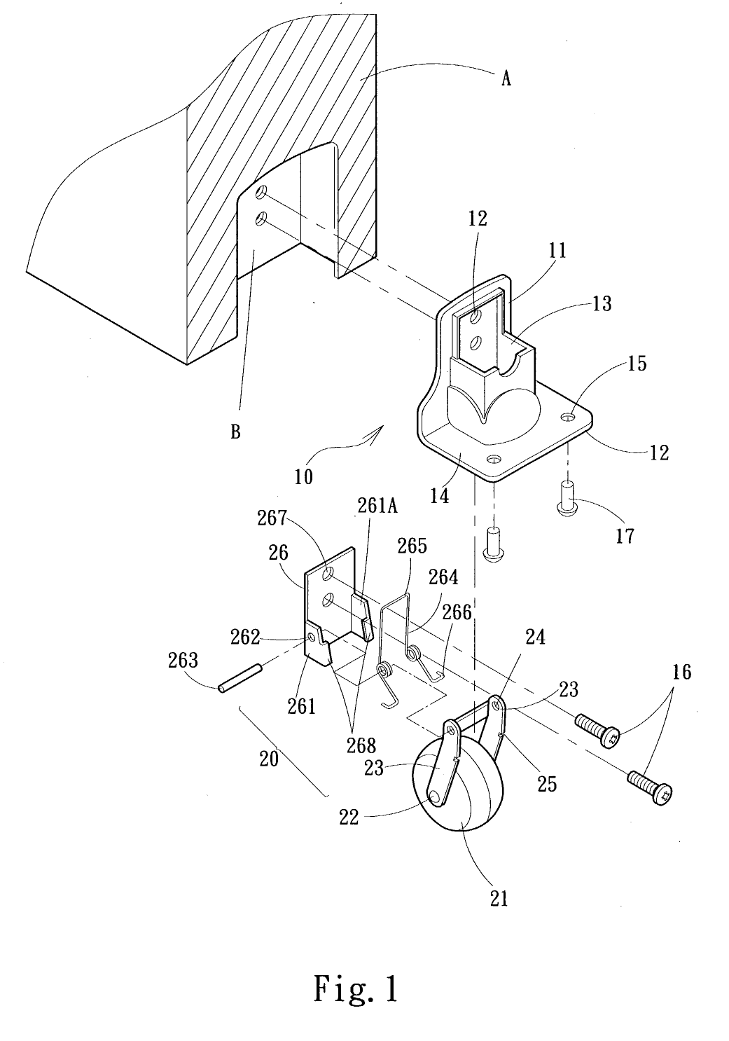

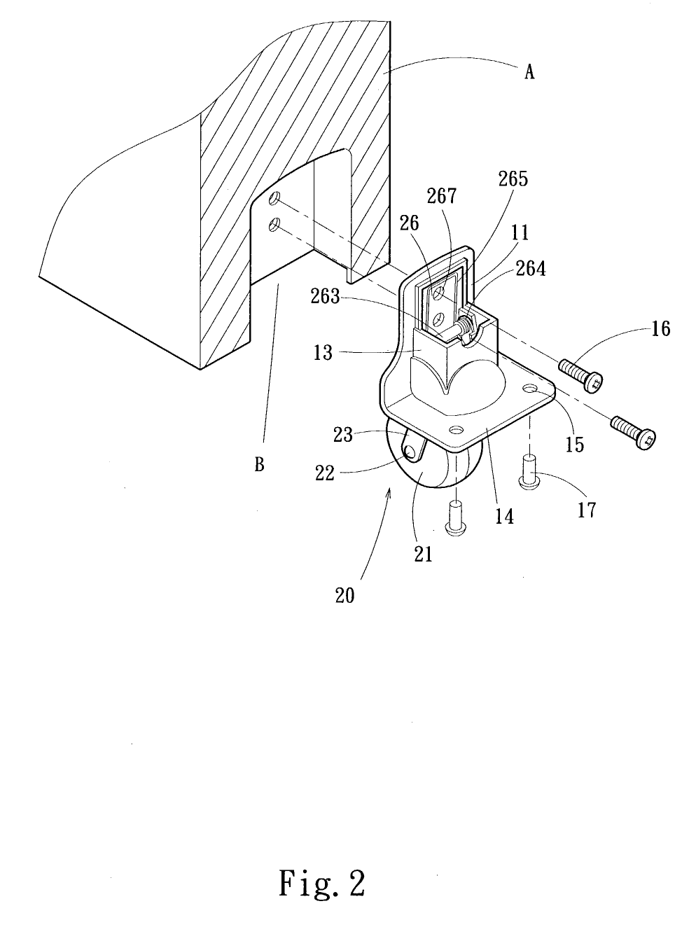

Referring to FIGS. 1 and 2, the shock-absorbing caster dock of the invention includes:

a dock shell 10 fastened to a bottom corner of a luggage A. It is made from plastics and formed in L-shape. It has an upright wall 11 on one side that has two fastening holes 12 formed thereon in an up and down manner. The upright wall 11 is extended to other side to form a hollow and upright square shell 13. The square shell 13 has a bottom section extending outwards to form a bottom wall 14. The bottom wall 14 has one rivet hole 15 formed respectively on a front and a rear section; and

a caster assembly 20 housed in the hollow shell 13. It includes a wheel 21 coupled on a transverse axle 22 in the center. The axle 22 has two sides pivotally engaging with a side lever 23. The side lever 23 has an upper side forming an aperture 24 and a lateral side forming a retaining notch 25. It also has a side wall 26 formed substantially in inverse U-shape to surround the upper portions of the two side levers 23. The side wall 26 includes a front wall 261 and a rear wall 261A located outside the side levers 23. The front side and rear side walls 261, 261A have respectively a hole 262 to receive a shaft 263 to engage with the aperture 24. There is an elastic element such as a spring 264 to couple with the middle portion of the shaft 263. The spring 264 has a middle section extending outwards to form a bucking section 265 to press an inner wall surface of the side wall 26 and a front end and a rear end bending outwards to form respectively the a hook 266. The hook 266 is latched on the retaining notch 25 of the side lever 23. The side wall 26 has two openings 267 corresponding to the two fastening holes 12. The front and rear side walls 261 are bent inwards to form respectively a flange 268. The flanges 268 are located on the inner side of the side levers 23 to restrict the turning curvature of the side wall 26 when it is subject to forces.

By means of the construction set forth above, the dock shell 10 is fastened to a recess B on the bottom of the luggage A through screws 16 engaging with the openings 267 of the side wall 26 and the fastening holes 12 of the dock shell 10. Then rivets 17 are used to run through the rivet holes 15 of the bottom wall 14 to fasten the bottom wall 14 to the bottom of the luggage A.

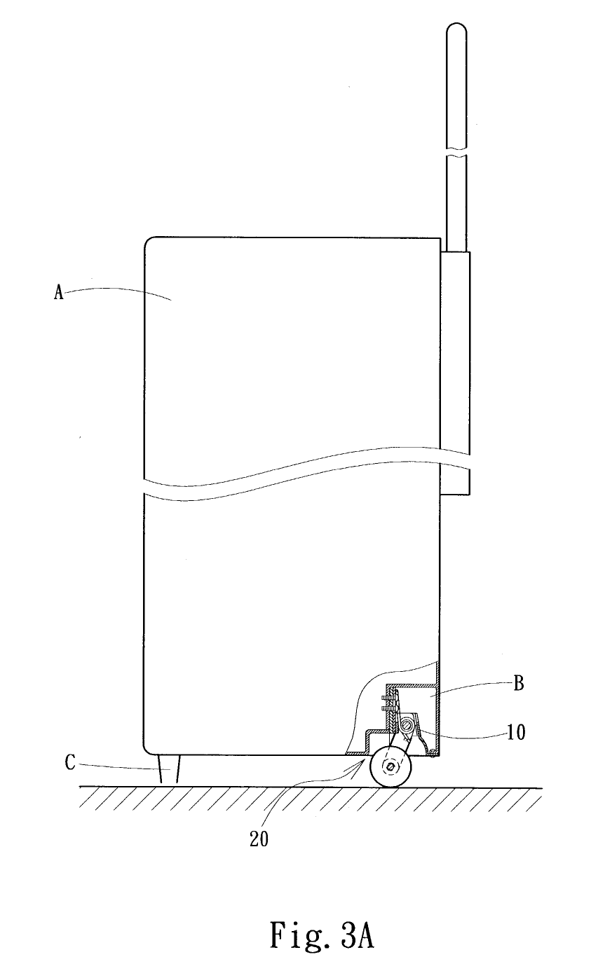

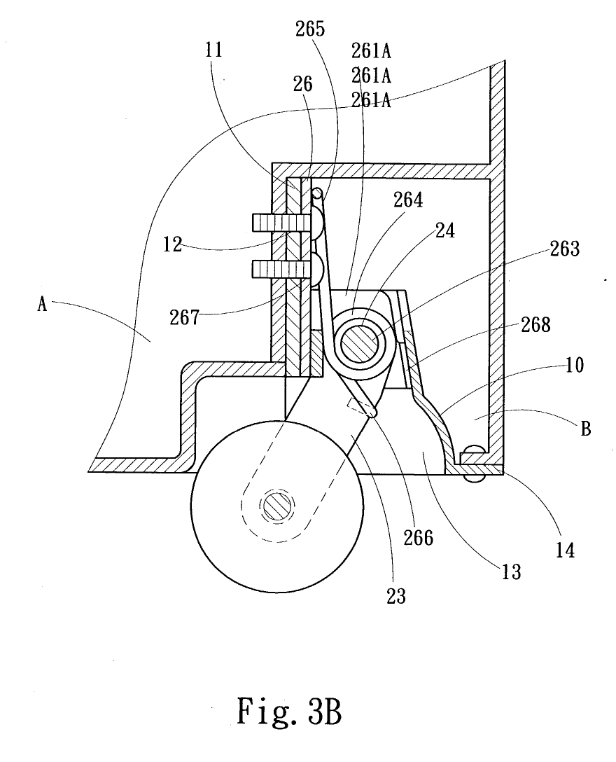

When the luggage A stands upright on the ground surface, the weight of the luggage A are supported by two feet C and two wheels 21. The side wall 26 of the caster assembly 20 can directly withstand the downward weight of the luggage A, and the gravity force is directly transferred to the ground surface through the wheels 21. The spring 264 does not bear the force (as shown in FIGS. 3A and 3B).

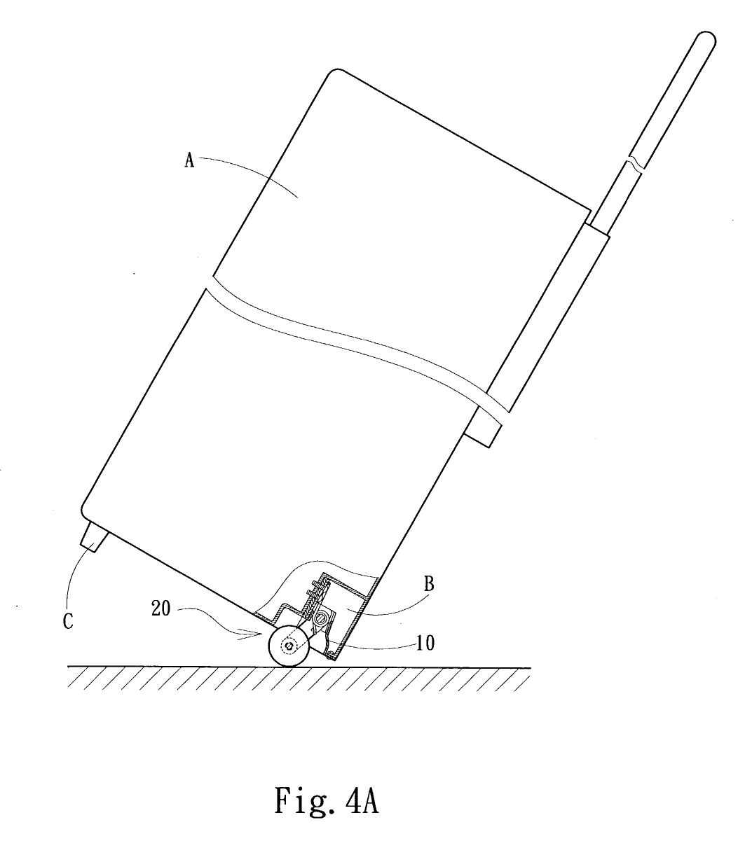

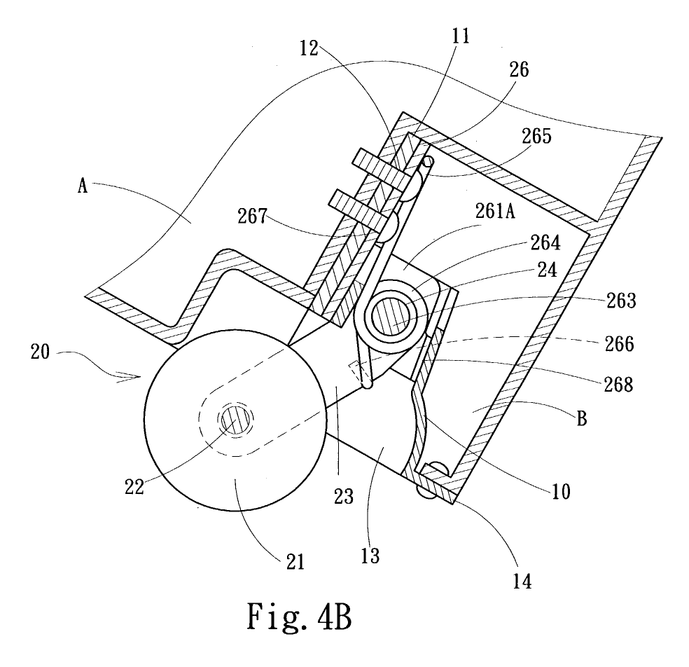

When the luggage A is towed through the pulling bar, the feet C are suspended without bearing force. The side wall 26 of the caster assembly 20 is inclined an angle with the ground surface that is equivalent to the inclined angle of the side wall 26 and the force receiving point of the wheels 21 and the ground surface. Referring to FIGS. 4A and 4B, as the side wall 26 and two levers 23 of the wheel 21 are pivotally engaged through the shaft 263, when the side wall 26 receives a force, the angle between the side wall 26 and the levers 23 changes. Since the shaft 263 is coupled with the spring 264, and the middle bucking section 265 of the spring 264 presses on the inner side of the side wall 26 and the two ends of the spring 264 latch on the retaining notches 25 of the two side levers 23, when the side wall 26 is inclined and receives the weight of the luggage A, the bending force of the side wall 26 is applied on the spring 264 and transferred to the ground surface through the two levers 23 and wheel 21. Thus when the wheel 21 rolls on the bumpy ground surface, vibrations are transferred inversely from the wheel 21 to the side levers 23 and absorbed by the spring 264 before reaching the side wall 26, and finally are transferred to the luggage A. Therefore with the shock-absorbing caster assembly mounted on the luggage A, when the luggage A is towed and moved on a bumpy road or ground surface, the elasticity provided by the invention can absorb the vibration, and the important and valuable articles contained in the luggage A may be prevented from shaking and being damaged.

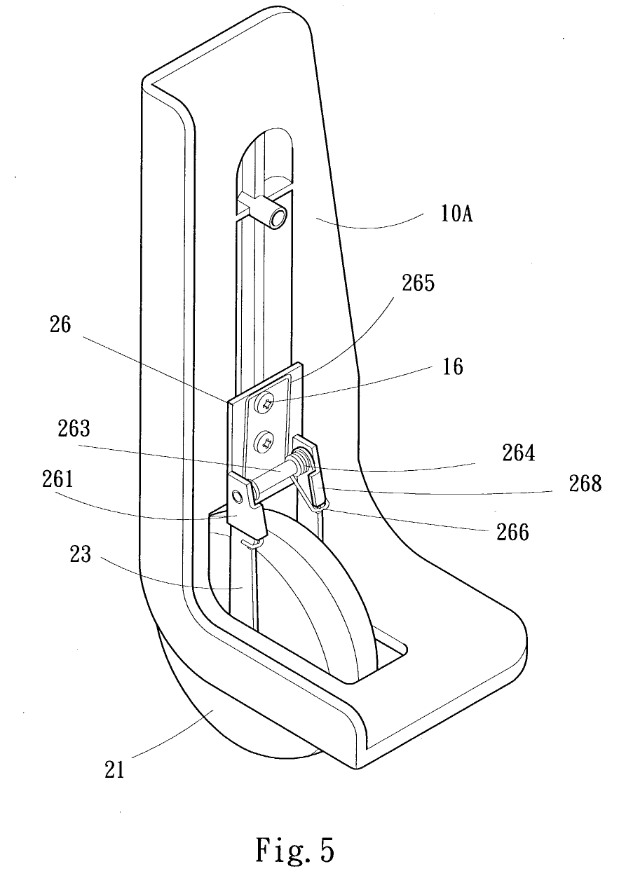

Refer to FIG. 5 for a second embodiment of the invention. It is substantially constructed like the first embodiment described above. However the shape of the dock shell 10A is altered slightly. And other elements also are enlarged to match the dock shell 10A. It may be fastened to a large trunk by means of two screws 16. All other features and functions are substantially the same.

What is claimed is:

1. A shock-absorbing caster dock to be fastened to the bottom of a luggage, comprising:
a dock shell having a upright wall fastened to a recess formed on the bottom of the luggage, the upright wall being extended to one side to form a hollow shell; and
a caster assembly located in the hollow shell including a wheel, an axle transversely running through the middle of the wheel, two side levers pivotally engaged with two ends of the axle, a shaft running through an upper section of the two side levers to pivotally engage with a side wall, and an elastic element coupling with the shaft, the elastic element having a bucking section in a middle portion to press the side wall and two ends latching on the side levers, the side wall being fastened to the upright wall of the dock shell.

2. The shock-absorbing caster dock of claim 1, wherein each of the side levers has a top section forming an aperture and one side forming a retaining notch, the side wall being substantially formed in inverse U-shape and having a front wall and a rear wall located outside the side levers, and two holes formed respectively on the front wall and the rear wall to couple with the shaft for running through the apertures of the side levers.

3. The shock-absorbing caster dock of claim 1, wherein the elastic element being a spring which has two ends latching on the retaining notches.

4. The shock-absorbing caster dock of claim 1, wherein the front wall and the rear wall of the side wall are bent inwards to form respectively a flange.

5. The shock-absorbing caster dock of claim 1, wherein the hollow shell of the dock shell is extended outwards to form a bottom wall which has a rivet hole located respectively on a front and a rear section to receive a rivet to fasten the dock shell to the luggage.
